(19) United States
(12) Patent Application Publication
(10) Pub. No.: US 2025/0240754 A1
(43) Pub. Date: Jul. 24, 2025

(54) SYSTEMS AND METHODS TO PROVIDE SUBSCRIPTION-BASED USER EQUIPMENT POLICY CONTROL

(71) Applicant: Verizon Patent and Licensing Inc., Basking Ridge, NJ (US)

(72) Inventors: Violeta Cakulev, Millburn, NJ (US); Lixia Yan, Basking Ridge, NJ (US); Lalit R. Kotecha, San Ramon, CA (US); Ce Xu, Campbell, CA (US)

(21) Appl. No.: 18/416,986

(22) Filed: Jan. 19, 2024

(51) Int. Cl. H04W 60/04; H04W 8/20; H04W 40/22

(52) U.S. Cl. CPC H04W 60/04; H04W 8/20; H04W 40/22

(57) ABSTRACT

A method may include receiving, by an access and mobility management function (AMF), a registration request from a user equipment (UE) device. The method may also include obtaining subscriber-related information associated with the UE device, wherein the subscriber-related information includes UE policy association information, and determining, based on the subscriber-related information, whether a UE policy association is enabled for the UE device. The method may further include transmitting, in response to determining that the UE policy association is enabled for the UE device, policy information to the UE device.

### BACKGROUND INFORMATION

In Fifth Generation (5G) network environments defined in accordance with the 3rd Generation Partnership Project (3GPP), a policy control function (PCF) may provide policy control information to various devices, such as a user equipment (UE) device. For example, the PCF may evaluate network policies and send UE Route Selection Policy (URSP) information to a UE device. The UE device may then operate in accordance with the received URSP information.

### BRIEF DESCRIPTION OF THE DRAWINGS

FIG. 1 illustrates an exemplary environment in which systems and methods described herein may be implemented;

FIG. 2 is a block diagram of components implemented in the environment of FIG. 1 in accordance with an exemplary implementation;

FIG. 3 illustrates logic components implemented in one or more of the devices illustrated in FIGS. 1 and 2 in accordance with an exemplary implementation;

FIGS. 4A and 4B are flow diagrams illustrating processing associated with establishing and removing a UE policy association in accordance with an exemplary implementation; and

FIG. 5 is an exemplary signal flow diagram associated with the processing of FIG. 4.

### DETAILED DESCRIPTION OF EXAMPLE EMBODIMENTS

The following detailed description refers to the accompanying drawings. The same reference numbers in different drawings may identify the same or similar elements.

Implementations described herein enable decisions regarding establishing and/or terminating a UE policy association to be based on user device subscription information. In an exemplary implementation, a unified data management (UDM) element and/or unified data repository (UDR) may store subscription-related information that indicates whether a UE policy association is to be established for a UE device. This information may be used by a network function (e.g., a policy control function (PCF) and/or an access and mobility management function (AMF)) to provide policy-related information to a UE device when a UE policy association is to be established. In addition, when changes occur to the subscription-related information, such as a UE policy association for a particular UE device is to be disabled, the PCF may transmit a message to the UE device indicating that any policy related rules based on the UE policy association are to be deleted.

The term “UE policy association” as used herein should be broadly construed to refer to UE policy control rules, UE policies and/or UE policy-related processing. For example, UE policies and/or rules associated with a UE policy association may include policies and/or rules to control access network discovery and selection policy information, (e.g., wireless local area network (WLAN) selection information, non-3GPP Inter-Working function (N3IWF) policy information, evolved packet data gateway (ePDG) selection information, etc.), UE route selection policy information (URSP) (e.g., association of an application with a packet data unit (PDU) session, network slice selection, etc.), as well as other policy control related processing.

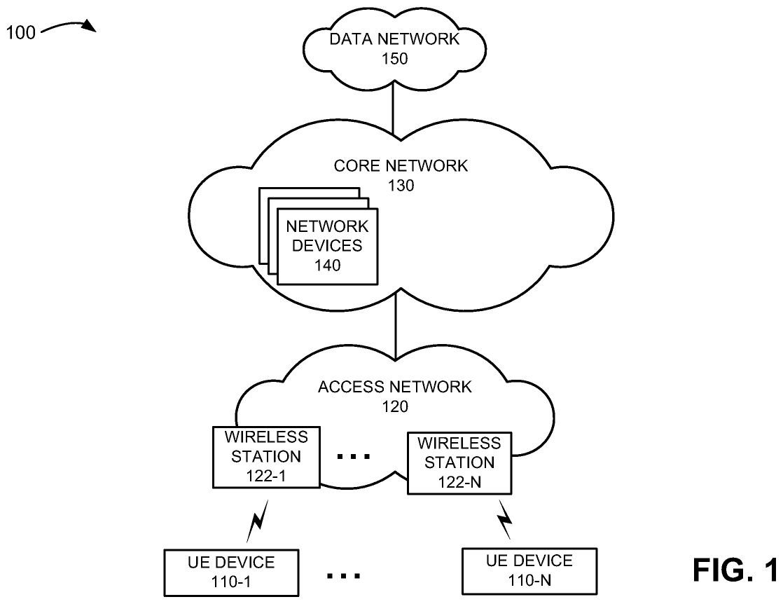

FIG. 1 is a diagram illustrating an exemplary environment 100 in which systems and methods described herein may be implemented. Referring to FIG. 1, environment 100 includes user equipment (UE) devices 110-1 through 110-N, access network 120, wireless stations 122-1 through 122-N, core network 130, network devices 140 and data network 150.

UE devices 110-1 through 110-N(referred to herein individually as UE device or UE 110, and collectively as UE devices or UEs 110) may include any computing device, such as a personal computer (PC), a laptop computer, a server, a tablet computer, a notebook, a Chromebook®, a mobile device, such as wireless or cellular telephone device (e.g., a conventional cell phone with data processing capabilities), a smart phone, a personal digital assistant (PDA) that can include a radiotelephone, any type of mobile computer device or system, a game playing device, a music playing device, a home appliance device, a home monitoring device, a virtualized system, an Internet of Things (IoT) device, a machine type communication (MTC) device, etc., that includes communication functionality. UE device 110-1 may connect to access network 120 via wireless station 122-1 and UE device 110-N may connect to access network 120 via wireless station 122-N. UE devices 110 may also connect to other devices in environment 100 via other techniques, such as wired, wireless, optical connections or a combination of these techniques. UE device 110 and a person that may be associated with UE device 110 (e.g., the party holding or using UE device 110) may be referred to collectively as UE device 110 or UE 110 in the description below.

Access network 120 may provide access to core network 130 for wireless devices, such as UE devices 110. Access network 120 may enable UE device 110 to connect to core network 130 for Internet access, non-Internet Protocol (IP) data delivery, cloud computing, mobile telephone service, Short Message Service (SMS) message service, Multimedia Message Service (MMS) message service, and/or other types of data services. Access network 120 may provide access to core network 130, a service or application layer network, a cloud network, a multi-access edge computing (MEC) network, a fog network, etc. Furthermore, access network 120 may enable a device in core network 130 to exchange data with UE device 110 using a non-IP data delivery method such as Data over Non-Access Stratum (DoNAS).

Access network 120 may also include a Fifth Generation (5G) access network or another advanced network, such as a Fourth Generation (4G) Long Term Evolution (LTE) access network. For example, access network 120 may include the functionality of a 5G network, such as 5G Radio Access Network (RAN) communicating via mmWave technology, a 5G RAN communicating via C-band technology or other types of 5G networks. Access network 120 may also include a 4G RAN.

Access network 120 may also include: support for advanced or massive multiple-input and multiple-output (MIMO) antenna configurations (e.g., an 8×8 antenna configuration, a 16×16 antenna configuration, a 256×256 antenna configuration, etc.); support for cooperative MIMO (CO-MIMO) configurations; support for carrier aggregation; relay stations; Heterogeneous Networks (HetNets) of overlapping small cells and macrocells; Self-Organizing Network (SON) functionality; machine type communication (MTC) functionality, such as 1.4 MHz wide enhanced MTC (eMTC) channels (also referred to as category Cat-M1), Low Power Wide Area (LPWA) technology such as Narrow Band (NB) IoT (NB-IoT) technology, and/or other types of MTC technology; and/or other types of 5G functionality.

Wireless stations 122-1 through 122-N(referred to collectively as wireless stations 122 and individually as wireless station 122) may be included in access network 120. Each wireless station 122 may service a number of UE devices 110 and/or other user devices when the particular device is within radio frequency range of wireless station 122. In one implementation, wireless station 122 may include 5G base station (e.g., a next generation NodeB (gNB)) that includes one or more radio frequency (RF) transceivers. For example, wireless station 122 may include three RF transceivers and each RF transceiver may service a 120 degree sector of a 360 degree field of view. Each RF transceiver may include or be coupled to an antenna array. The antenna array may include an array of controllable antenna elements configured to send and receive 5G new radio (NR) wireless signals via one or more antenna beams. In other implementations, wireless station 122 may also include a 4G base station (e.g., an evolved NodeB (eNodeB)) or a 6G base station that communicates wirelessly with UEs 110 located within the radio frequency range of wireless station 122.

Core network 130 may include one or more wired, wireless and/or optical networks that are capable of receiving and transmitting data, voice and/or video signals. In an exemplary implementation, core network 130 may be associated with a telecommunications service provider (e.g., a cellular wireless communication service provider and/or wired communication service provider) and may manage communication sessions of UE devices 110 connecting to core network 130 via access network 120. Core network 130 may include one or multiple networks of different types and technologies. For example, core network 130 may be implemented to include a next generation core (NGC) network for a 5G network, an Evolved Packet Core (EPC) of an LTE or LTE Advanced network, a sixth generation (6G) network, and/or a legacy core network. Core network 130 may provide packet-switched services and wireless IP connectivity to various components in environment 100, such as UE devices 110, to provide, for example, data, voice, and/or multimedia services.

Core network 130 may include various network devices 140. Depending on the implementation, network devices 140 may include 5G core network components (e.g., a User Plane Function (UPF), an Access and Mobility Management Function (AMF), a Session Management Function (SMF), a Unified Data Management (UDM) function, a Unified Data Repository (UDR), a Policy Control Function (PCF), a Charging Function (CHF), a network exposure function (NEF), an application function (AF), etc.), 4G core network components (e.g., a Serving Gateway (SGW), a Packet data network Gateway (PGW), a Mobility Management Entity (MME), a Home Subscriber Server (HSS), a Policy Charging and Rules Function (PCRF) etc.), or another type of core network components (e.g., future 6G network components). In another implementation, network devices 140 may include combined 4G and 5G functionality, such as a session management function with PGW-control plane (SMF+PGW-C) and a user plane function with PGW-user plane (UPF+PGW-U).

Data network 150 may include, for example, a packet data network. In an exemplary implementation, UE device 110 may connect to data network 150 via core network 130. Data network 150 may also include and/or be connected to a local area network (LAN), a wide area network (WAN), a metropolitan area network (MAN), an autonomous system (AS) on the Internet, an optical network, a cable television network, a satellite network, a wireless network, an ad hoc network, a telephone network (e.g., the Public Switched Telephone Network (PSTN) or a cellular network), an intranet, or a combination of networks.

The exemplary configuration illustrated in FIG. 1 is provided for simplicity. It should be understood that a typical environment may include more or fewer devices than illustrated in FIG. 1. For example, environment 100 may include a large number (e.g., thousands or more) of UE devices 110 and wireless stations 122, as well as multiple access networks 120, core networks 130 and data networks 150. Environment 100 may also include elements, such as gateways, monitoring devices, network elements/functions, etc. (not shown), that aid in providing data services and routing data in environment 100.

Various functions are described below as being performed by particular components in environment 100. In other implementations, various functions described as being performed by one device may be performed by another device or multiple other devices, and/or various functions described as being performed by multiple devices may be combined and performed by a single device.

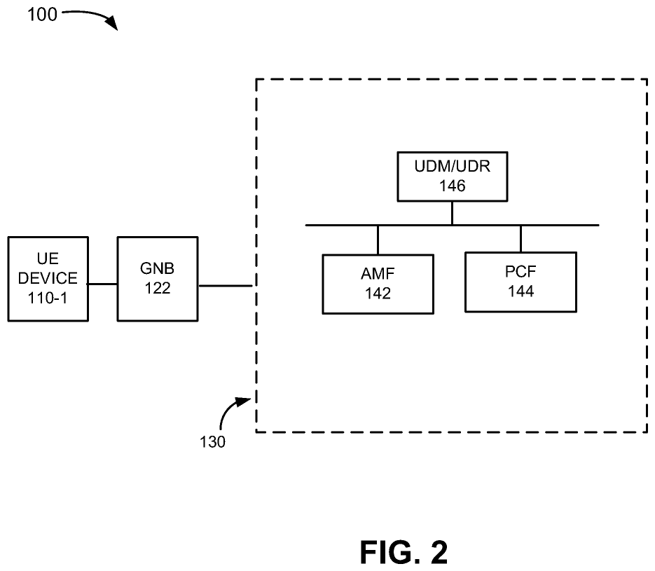

FIG. 2 illustrates a portion of environment 100, including elements implemented in core network 130 in accordance with an exemplary implementation. Referring to FIG. 2, network devices 140 in core network 130 include AMF 142, PCF 144 and UDM/UDR 146. It should be understood that core network 130 may include other elements/functions, such as those elements/functions described above with respect to FIG. 1, and/or differently arranged elements. Environment 100 also includes UE device 110-1 and wireless station 122 (depicted as gNB 122).

AMF 142 may perform registration management, connection management, reachability management, mobility management, lawful intercepts, SMS transport between UE device 110 and other network functions, session management messages transport between UE device 110 and an SMF (not shown), access authentication and authorization, location services management, functionality to support non-3GPP access networks, and/or other types of management processes. In exemplary implementations, AMF 142 may obtain subscription information associated with UE devices 110 from, for example, UDM/UDR 146. AMF 142 may forward a portion of the subscription information to PCF 144. When a subscription change occurs, such as when a UE device 110 disables a UE policy association, AMF 142 may forward the subscription update to PCF 144, as described in detail below.

PCF 144 may perform policy control functions. For example, PCF 144 may support policies to control network behavior, provide policy rules to control plane functions (e.g., to an SMF, not shown), access and/or receive subscription information relevant to policy decisions, generate policy decisions, and/or perform other types of processes associated with policy enforcement. In an exemplary implementation, PCF 144 may transmit trigger information to AMF 142 indicating that PCF 144 is to be notified regarding subscription information for UE devices 110 registered at core network 130, as well as being notified if UE devices 110 change their subscription information. PCF 144 may then determine whether to remove rules associated with a UE policy association that has been established with the particular UE based on the prior subscription information (e.g., the subscription information prior to the change), as described in detail below.

UDM/UDR 146, shown as a single device in FIG. 2 may include both a UDM and a UDR. The UDM and UDR may be referred to together herein as UDM/UDR 146. The UDM portion of UDM/UDR 146 may maintain subscription information for UE devices 110, manage subscriptions, generate authentication credentials, handle user identification, perform access authorization based on subscription data, perform network function registration management, maintain service and/or session continuity by maintaining assignment of an SMF (not shown) for ongoing sessions, support SMS delivery, support lawful intercept functionality, and/or perform other processes associated with managing user data. The UDR portion of UDM/UDR 146 may store the subscription information obtained and managed by the UDM.

For example, the UDR may store subscription information and subscriber profile information obtained by the UDM, such as whether UE policy control is enabled or disabled for various UE devices 110. In an exemplary implementation, UDM/UDR 146 may provide an indication of whether a UE policy control is enabled or disabled indication to AMF 142 when a UE device 110 is registering and when a subscription for a UE 110 changes, as described in detail below.

Environment 100 illustrated in FIG. 2 may include additional elements and/or network functions (NFs) that are not illustrated. Such elements and/or NFs may provide security, authentication and authorization, network polices, subscriber profiles, network slicing, and/or facilitate the operation of core network 130. It should also be understood that functions described as being performed by various elements in FIG. 2, including elements in core network 130, may be performed by other elements/functions in other implementations.

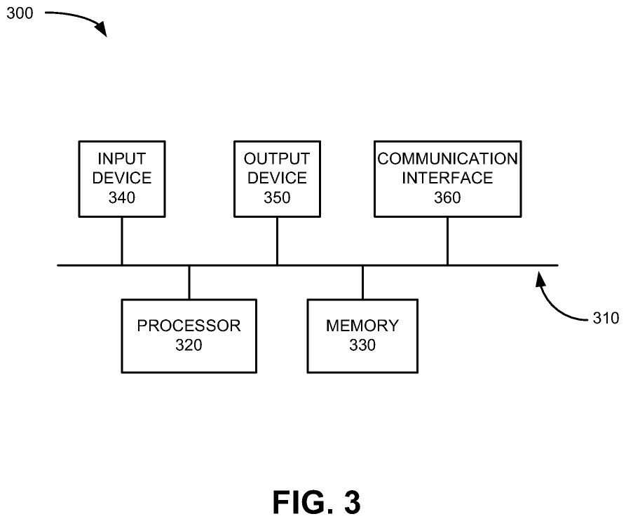

FIG. 3 illustrates an exemplary configuration of a device 300. One or more devices 300 may correspond to or be included in devices in environment 100, such as UE device 110, wireless station 122, network devices 140 (e.g., AMF 142, PCF 144, UDM/UDR 146), and other devices included in environment 100. Referring to FIG. 3, device 300 may include bus 310, processor 320, memory 330, input device 340, output device 350 and communication interface 360. The exemplary configuration illustrated in FIG. 3 is provided for simplicity. It should be understood that device 300 may include more or fewer components than illustrated in FIG. 3.

Processor 320 may include one or more processors, microprocessors, or processing logic that may interpret and execute instructions. Memory 330 may include a random access memory (RAM) or another type of dynamic storage device that may store information and instructions for execution by processor 320. Memory 330 may also include a read only memory (ROM) device or another type of static storage device that may store static information and instructions for use by processor 320. Memory 330 may further include a solid state drive (SSD). Memory 330 may also include a magnetic and/or optical recording medium (e.g., a hard disk) and its corresponding drive.

Input device 340 may include a mechanism that permits a user to input information, such as a keypad, a keyboard, a mouse, a pen, a microphone, a touch screen, voice recognition and/or biometric mechanisms, etc. Output device 350 may include a mechanism that outputs information to the user, including a display (e.g., a liquid crystal display (LCD)), a speaker, etc. In some implementations, device 300 may include a touch screen display that may act as both an input device 340 and an output device 350.

Communication interface 360 may include one or more transceivers that device 300 uses to communicate with other devices via wired, wireless or optical mechanisms. For example, communication interface 360 may include one or more radio frequency (RF) transmitters, receivers and/or transceivers and one or more antennas for transmitting and receiving RF data. Communication interface 360 may also include a modem or an Ethernet interface to a LAN or other mechanisms for communicating with elements in a network.

In an exemplary implementation, device 300 performs operations in response to processor 320 executing sequences of instructions contained in a computer-readable medium, such as memory 330. A computer-readable medium may be defined as a physical or logical memory device. The software instructions may be read into memory 330 from another computer-readable medium (e.g., a hard disk drive (HDD), SSD, etc.), or from another device via communication interface 360. Alternatively, hard-wired circuitry may be used in place of or in combination with software instructions to implement processes consistent with the implementations described herein. Thus, implementations described herein are not limited to any specific combination of hardware circuitry and software.

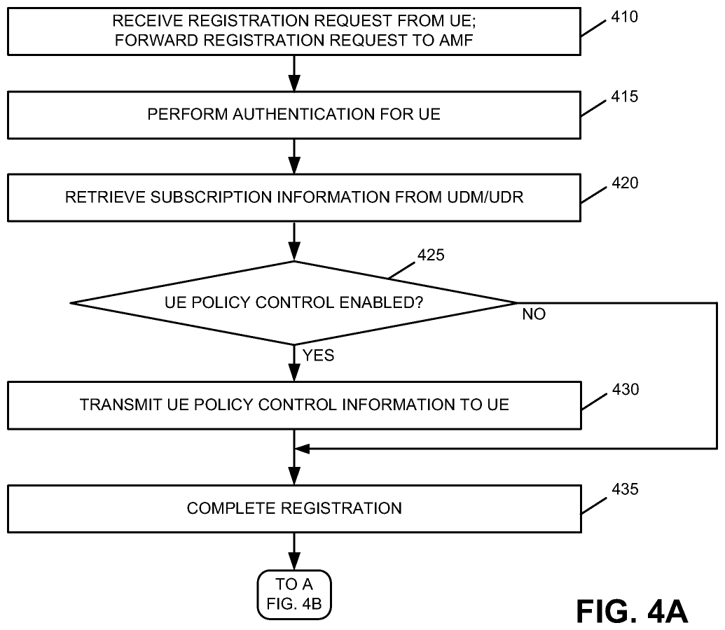

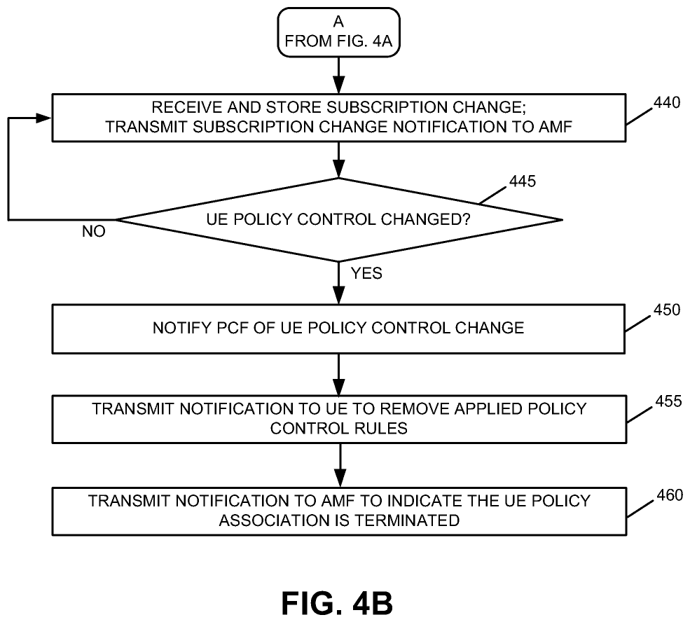

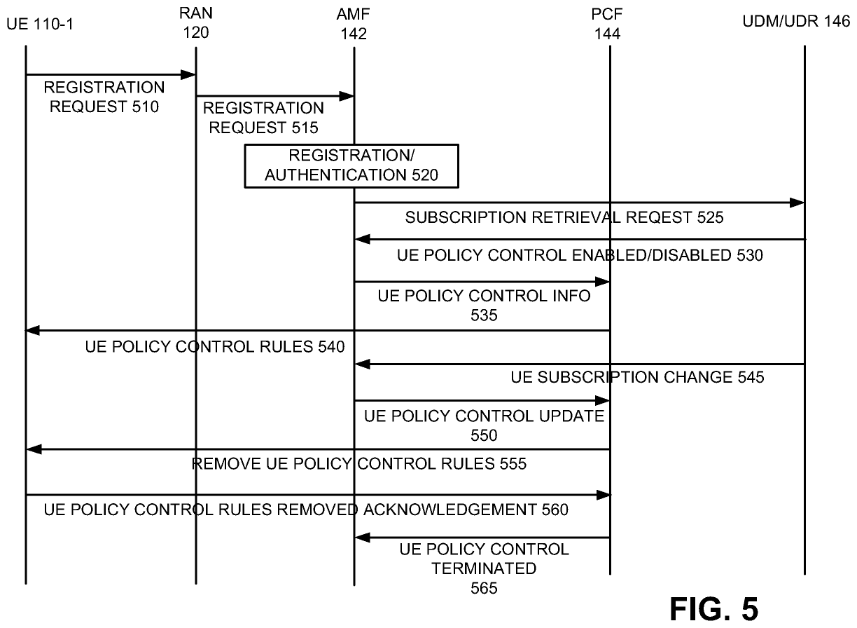

FIGS. 4A and 4B are flow diagrams illustrating processing associated with establishing and removing or terminating UE policy association with respect to UE devices 110 in accordance with an exemplary implementation. FIG. 5 is a signal flow diagram illustrating exemplary signal flows associated with the processing of FIGS. 4A and 4B. Processing may begin with a UE device 110 transmitting a registration request and RAN 120 receiving the registration request (FIG. 4A, block 410; FIG. 5, 510). For example, UE 110-1 may transmit a registration request and wireless station 122-1 may receive the registration request. RAN 120 may forward the registration request to AMF 142 (block 410; FIG. 5, 515).

AMF 142 may receive the registration request and perform authentication associated with registering UE 110-1 (block 415; FIG. 5, block 520). For example, AMF 142 may determine if UE 110-1 is authorized to establish a data session, such as whether UE 110-1 is associated with a subscriber to core network 130. For this example, assume that UE 110-1 is authenticated by core network 130.

AMF 142 may also retrieve subscription information associated with UE 110-1 from UDM/UDR 146 (block 420). For example, AMF 142 may transmit a subscription retrieval request to UDM/UDR 146 (FIG. 5, 525). In an exemplary implementation, UDM/UDR 146 may store subscriber data, including an indication whether a policy association is enabled for UE devices 110. UDM/UDR 146 may provide the indication as a policy control information element (IE) to AMF 142. For example, UDM/UDR 146 may have stored an indication that UE policy control is enabled for particular UE devices 110, such as UE devices 110 associated with premium subscribers, UE devices 110 associated with subscribers having a particular quality of service (QoS) or service level agreement (SLA) requirements, etc. UDM/UDR 146 may also have stored an indication that UE policy control is disabled for particular UE devices 110. In each case, such as for UE device 110-1 registering, UDM/UDR 146 may provide the subscriber data and the information indicating whether UE policy control is enabled or disabled for UE 110-1 to AMF 142 (FIG. 5, 530).

AMF 142 may receive the information from UDM/UDR 146 and determine whether UE policy control is enabled for UE 110-1 (block 425). For example, AMF 142 may check the UE policy control IE from UDM/UDR 146 to determine if UE policy control is enabled or disabled. If AMF 142 determines that UE policy control is enabled for UE 110-1 (block 425—yes), AMF 142 may interact with PCF 144 to signal PCF 144 that UE policy control is enabled for UE 110-1. For example, as described above, PCF 144 may have provided policy request triggers to AMF 142, prior to UE devices 110 registering in environment 100. The policy request triggers define conditions in which AMF 142 is to notify PCF 144 of various information (e.g., UE policy control enabled/disabled status). AMF 142 may have stored these triggers received from PCF 144. In one implementation, a trigger may indicate that each time AMF 142 receives information regarding UE policy control being enabled/disabled for a UE 110 from UDM/UDR 146, AMF 142 is to provide this information to PCF 144. In this example, based on the stored trigger information and AMF 142 receiving the UE policy control information from UDM/UDR 146 for UE 110-1, assume that AMF 142 signals PCF 144 that UE policy control is enabled for UE 110-1 (FIG. 5, 535).

PCF 144 may then evaluate policies associated with environment 100 and transmit policy information to UE 110-1 (block 430; FIG. 5, 540). For example, PCF 144 may transmit policy information indicating that UE 110-1 is to use particular URSP rules when transmitting data and/or transmit the particular URSP rules to UE device 110-1. If AMF 142 determines that UE policy control is disabled for UE 110-1 (block 425-no), AMF 142 may not send any information to PCF 144 regarding UE policy control for UE 110-1, and processing may continue. In either case (i.e., UE policy control enabled or disabled based on stored subscription information), UE registration for UE 110-1 may be completed (block 435).

Assume that a subscription change occurs for UE 110-1. For example, UE 110-1 may no longer need to use a particular slice, may no longer need a particular QoS, SLA, etc. In this case, a user associated with UE 110-1 may initiate the subscription change. UDM/UDR 146 may receive and store the subscription change information (FIG. 4B, block 440). UDM/UDR 146 may also notify AMF 142 that a subscription change for UE 110-1 has occurred (block 440; FIG. 5, 545).

AMF 142 may receive the subscription change notification and determine if a UE policy control change has occurred (block 445). If AMF 142 determines that a UE policy control change has not occurred (block 445-no), processing may return to block 440. If, however, AMF 142 determines that a UE policy control change has occurred (block 445—yes), AMF 142 may transmit subscription change update information to PCF 144 (block 450; FIG. 5, 550). For example, as discussed above, AMF 142 may have received trigger information from PCF 144 indicating when AMF 142 is to interact with PCF 144. In an exemplary implementation, one such trigger may be that when a UE policy control update based on a change in subscriber information is received, AMF 142 is to notify PCF 144 of such a change. In this example, PCF 144 may receive the subscription change information from AMF 142 and determine if UE policy control for UE 110-1 has changed, such as determine whether UE policy control for UE 110-1 has been disabled.

If PCF 144 determines that UE policy control for UE 110-1 is not disabled, PCF 144 may take no action. If, however, PCF 144 determines that UE policy control for UE 110-1 has been disabled, PCF 144 may re-evaluate policy information sent to UE 110-1. In an exemplary implementation, PCF 144 may transmit a notification to UE 110-1 instructing UE 110-1 to remove or delete applied policy control processing and/or rule(s) for UE 110-1, such as delete one or more URSP rules being applied at UE device 110-1 (block 455; FIG. 5, 555). UE 110-1 may then delete or terminate application of the URSP rules at UE 110-1 and send an acknowledgment to PCF 144 that the URSP rules have been deleted (FIG. 5, 560). PCF 144 may receive the acknowledgement from UE 110-1 indicating that the UE policy association related processing and/or rule(s) has been removed or deleted at UE 110-1. PCF 144 then may transmit a notification to AMF 142 to terminate the UE policy control association that was established for UE 110-1 (block 460; FIG. 5, 565).

In this manner, applied UE policy associated related processing applied to a UE 110 may be efficiently removed, when necessary. This may help avoid service interruptions at UE device 110-1, as well as ensure that UE device 110-1 is using an appropriate slice, or other rules associated with a UE policy association.

Implementations described herein provide for determining whether to establish a UE policy association for a UE device data session based on subscriber information. Implementations described herein also provide for terminating a UE policy association based on a change in user device subscription information. In such an implementation, a network function (e.g., PCF) may transmit a message to the UE device indicating that any policy related rules based on the UE policy association are to be deleted. This may improve processing efficiency at a UE device, as well as ensure that a UE device is not causing the network to unnecessarily use network resources, such as using resources associated with an incorrect slice for the particular UE device.

The foregoing description of example implementations provides illustration and description, but is not intended to be exhaustive or to limit the embodiments to the precise form disclosed. Modifications and variations are possible in light of the above teachings or may be acquired from practice of the embodiments.

In addition, features have been described with respect to generating UE policy association decisions using elements in core network 130. In other implementations, similar processing may be performed in other portions of environment 100, such as in a Multi-access Edge Computing (MEC) platform located, for example, between access network 120 and core network 130. In still other implementations, a number of AMFs 142, PCFs 144 and/or UDM/UDRs 146 may be distributed in environment 100 to generate UE policy association determinations and remove various UE policy related rules, if necessary.

Further, features have been described above with respect to an AMF 142 requesting information from a UDM/UDR 146 and reporting subscription information to PCF 144. In other implementations, AMF 142 and/or PCF 144 may subscribe to event information and/or other information from UDM/UDR 146. In such implementations, AMF 142 and/or PCF 144 may obtain the UE policy association information enabled or disabled indication without having to request such information.

Still further, while series of acts have been described with respect to FIGS. 4A and 4B and signal flows with respect to FIG. 5, the order of the acts and signal flows may be different in other implementations. Moreover, non-dependent acts may be implemented in parallel.

It will be apparent that various features described above may be implemented in many different forms of software, firmware, and hardware in the implementations illustrated in the figures. The actual software code or specialized control hardware used to implement the various features is not limiting. Thus, the operation and behavior of the features were described without reference to the specific software code-it being understood that one of ordinary skill in the art would be able to design software and control hardware to implement the various features based on the description herein.

Further, certain portions of the invention may be implemented as “logic” that performs one or more functions. This logic may include hardware, such as one or more processors, microprocessor, application specific integrated circuits, field programmable gate arrays or other processing logic, software, or a combination of hardware and software.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

To the extent the aforementioned embodiments collect, store or employ personal information of individuals, it should be understood that such information shall be collected, stored and used in accordance with all applicable laws concerning protection of personal information. Additionally, the collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

No element, act, or instruction used in the description of the present application should be construed as critical or essential to the invention unless explicitly described as such. Also, as used herein, the article “a” is intended to include one or more items. Further, the phrase “based on” is intended to mean “based, at least in part, on” unless explicitly stated otherwise.

What is claimed is:

1. A method, comprising:
receiving, by an access and mobility management function (AMF), a registration request from a user equipment (UE) device;
obtaining, by the AMF, subscriber-related information associated with the UE device, wherein the subscriber-related information includes UE policy association information;
determining, based on the subscriber-related information, whether a UE policy association is enabled for the UE device; and
transmitting, in response to determining that the UE policy association is enabled for the UE device, policy information to the UE device.

2. The method of claim 1, further comprising:
receiving, by the AMF, information associated with a subscription change for the UE device;
forwarding, by the AMF, the subscription change information, to a policy control function (PCF);
determining, by the PCF and based on the subscription change information, whether the UE policy association for the UE device is disabled; and
transmitting a message to the UE device to remove, delete or terminate at least one rule associated with the UE policy association.

3. The method of claim 2, wherein the at least one rule comprises a UE route selection policy (URSP) rule.

4. The method of claim 2, further comprising:
receiving, by the PCF and from the UE device, an acknowledgement that the at least one rule was removed, and
signaling, by the PCF and to the AMF, that the UE policy association has been terminated for the UE device.

5. The method of claim 1, wherein the obtaining subscriber-related information comprises:
obtaining subscriber-related information for the UE device from at least one of a unified data management (UDM) device or a unified data repository (UDR), wherein the subscriber-related information indicates whether the UE policy association for the UE device is enabled or disabled.

6. The method of claim 1, wherein the transmitting comprises:
transmitting at least one rule to the UE device based on the UE policy association being enabled for the UE device, the method further comprising:
transmitting, in response to determining that the UE policy associated is disabled for the UE device, information to the UE device to terminate application of the at least one rule.

7. The method of claim 1, further comprising:
receiving, by the AMF, UE policy control subscription change information; and
notifying, by the AMF, a policy control function (PCF) of the UE policy control subscription change.

8. The method of claim 1, further comprising:
storing, by a unified data management (UDM) device or a unified data repository (UDR), UE policy information for each of a plurality of UE devices, wherein the UE policy information indicates whether the UE policy association is enabled.

9. The method of claim 8, further comprising:
providing, by a policy control function (PCF) and to the AMF, trigger information, wherein the trigger information identifies when the AMF is to signal the PCF with information regarding UE device policy association information.

10. A system, comprising:
at least one device configured to:
receive a registration request from a user equipment (UE) device,
obtain subscriber-related information associated with the UE device, wherein the subscriber-related information includes UE policy association information,
determine, based on the subscriber-related information, whether a UE policy association is enabled for the UE device, and
transmit, in response to determining that the UE policy association is enabled for the UE device, policy information to the UE device.

11. The system of claim 10, wherein the at least one device comprises an access and mobility management function (AMF) and a policy control function (PCF).

12. The system of claim 10, wherein the at least one device is further configured to:
receive information associated with a subscription change for the UE device,
determine, based on the subscription change information, whether the UE policy association for the UE device is disabled, and
transmit a message to the UE device to remove, delete or terminate at least one rule associated with the UE policy association.

13. The system of claim 10, wherein when obtaining, the at least one device is configured to:
obtain subscriber-related information for the UE device from at least one of a unified data management (UDM) device or a unified data repository (UDR), wherein the subscriber-related information indicates whether the UE policy association for the UE device is enabled.

14. The system of claim 10, wherein when transmitting, the at least one device is configured to:
transmit at least one rule to the UE device based on the UE policy association, and wherein the at least one device is further configured to:
transmit, in response to a subscription change for the UE device indicating that UE policy associated for the UE device is disabled, a message to the UE device indicating that the at least one rule associated with the UE policy association is to be removed, deleted or terminated.

15. The system of claim 10, wherein the at least one device is further configured to:
store UE policy information for each of a plurality of UE devices, wherein the UE policy information indicates whether the UE policy association is enabled or disabled.

16. The system of claim 10, wherein the at least one device is further configured to:
provide trigger information to an access and mobility management function (AMF), wherein the trigger information identifies when the AMF is to signal a policy control function (PCF) with information regarding UE device policy association information.

17. The system of claim 10, wherein the at least one device is configured to determine, based on the subscriber-related information, whether to establish a UE policy association for the UE device or remove an established UE policy association for the UE device.

18. A non-transitory computer-readable medium having stored thereon sequences of instructions which, when executed by at least one processor, cause the at least one processor to:
receive subscriber-related information associated with a user equipment (UE) device, wherein the subscriber-related information includes UE policy association information;
determine, based on the subscriber-related information, whether a UE policy association is enabled for the UE device; and
transmit, in response to determining that the UE policy association is enabled for the UE device, policy information to the UE device.

19. The non-transitory computer-readable medium of claim 18, wherein the instructions further cause the at least one processor to:
receive information associated with a subscription change for the UE device;
determine, based on the subscription change information, whether the UE policy association for the UE device is disabled; and
transmit, in response to determining that the UE policy associated for the UE device is disabled, a message to the UE device to remove, delete or terminate at least one rule associated with the UE policy association.

20. The non-transitory computer-readable medium of claim 18, wherein when obtaining information, the instructions cause the at least one processor to:
obtain subscriber-related information for the UE device via at least one of a unified data management (UDM) device or a unified data repository (UDR), wherein the subscriber-related information indicates whether the UE policy association for the UE device is enabled or disabled.
